(19) United States
(12) Patent Application Publication
(10) Pub. No.: US 2024/0088965 A1
(43) Pub. Date: Mar. 14, 2024

(54) Techniques For Channel State Information (CSI) Compression

(71) Applicant: MediaTek Inc., Hsinchu City (TW)

(72) Inventors: Pedram Kheirkhah Sangdeh, San Jose, CA (US); Gyu Bum Kyung, San Jose, CA (US)

(21) Appl. No.: 18/242,090

(22) Filed: Sep. 5, 2023

Related U.S. Application Data
(60) Provisional application No. 63/375,396, filed on Sep. 13, 2022.

(51) Int. Cl. H04B 7/06; G06N 20/00

(52) U.S. Cl. CPC H04B 7/0626; G06N 20/00; H04B 7/0617

(57) ABSTRACT

Techniques pertaining to channeling state information (CSI) compression are described. A user equipment (UE) that is in wireless communication with a base station node acquires channel state information (CSI) at least associated with the wireless communication. The UE further compresses the CSI into CSI feedback for the base station node via an artificial intelligence (AI)/machine-learning (ML)-based encoder that implements at least one of convolutional projection, expandable kernels, or multi-head re-attention (MHRA).

### CROSS REFERENCE TO RELATED PATENT APPLICATION(S)

The present disclosure is part of a non-provisional application claiming the priority benefit of U.S. Patent Application No. 63/375,396, filed 13 Sep. 2022, the content of which herein being incorporated by reference in its entirety.

### TECHNICAL FIELD

The present disclosure is generally related to wireless communications and, more particularly, to channel state information (CSI) compression and processing.

### BACKGROUND

Unless otherwise indicated herein, approaches described in this section are not prior art to the claims listed below and are not admitted as prior art by inclusion in this section. Channel state information (CSI) compression is a study item (SI) in 3GPP NR Rel-18. In the two-sided artificial intelligence (AI)/machine-learning (ML) architecture for CSI compression, the first part of the architecture is implemented on a user equipment (UE), and the second part of the architecture is implemented on a base station node, e.g., a gNodeB (gNB) of a wireless carrier network. The AI/ML architecture may include the use of AI or the use of ML. Accordingly, the term AI/ML as used herein refers to the use of AI or ML, in which ML may be a specific application of AI. In the first part of the architecture, the UE may pre-processes the CSI input into a form that is suitable for compression, and then compresses the pre-processed or un-preprocessed CSI into an abstract representation of the semantic features of the CSI using an AI/ML-based encoder. In the second part of the architecture, the base station node receives the abstract representation of the CSI as feedback from the UE. The base station node then decompresses the abstract representation using an AI/ML-based decoder to reconstruct the CSI. In some instances, post-processing may be further applied by the base station node following decompression to reconstruct the CSI. The reconstructed CSI is used by the base station node for various applications, such as scheduling beamforming for the antennas of the base station node, etc.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for enhancing the compression of CSI by an AI/ML-based encoder of the EU and to boost the performance of the AI/ML-based encoder, such that the compression of the CSI into an abstract representation may be improved. Thus, it is believed that implementations of various proposed schemes in accordance with the present disclosure may improve the operation of the AI/ML models for CSI compression in wireless communications.

In one aspect, a method may include a UE that is in wireless communication with a base station node acquiring CSI at least associated with the wireless communication. The method may also involve the UE compressing the CSI into CSI feedback for the base station node via an AI/ML-based encoder that implements at least one of convolutional projection, expandable kernels, or multi-head re-attention (MHRA).

In another aspect, a method may include a base station node receiving CSI feedback from a UE that is generated by the UE, the CSI feedback being generated from CSI acquired by the UE via an AI/ML-based encoder of the UE that implements at least one of convolutional projection, expandable kernels, or MHRA to compress the CSI into the CSI feedback. The method may also include decompressing the CSI feedback into reconstructed CSI via an AI/ML-based decoder of the base station node that implements at least one of convolutional projection, expandable kernels, or MHRA.

In yet another aspect, an apparatus may include a transceiver configured to communicate wirelessly and a processor coupled to the transceiver. The processor may acquire CSI at least associated with wireless communication. The processor may also compress the CSI into CSI feedback for the base station node via an AI/ML-based encoder that implements at least one of convolutional projection, expandable kernels, or MHRA.

It is noteworthy that, although description provided herein may be in the context of certain radio access technologies, networks, and network topologies for wireless communication, such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 illustrates the first technique for improving CSI compression in accordance with the present disclosure.

FIG. 3 illustrates the second technique for improving CSI compression in accordance with the present disclosure.

FIG. 4 illustrates the third technique for improving CSI compression in accordance with the present disclosure.

FIG. 5 illustrates an example implementation of a technique for improving CSI compression in accordance with the present disclosure.

FIG. 6 illustrates example implementations of an AI/ML-based encoder for encoding CSI that uses multiple techniques in accordance with the present disclosure.

FIG. 7 illustrates an example implementation of an AI/ML-based encoder for encoding CSI that uses expandable kernels with existing AI/ML-based encoders in accordance with the present disclosure.

FIG. 8 illustrates example implementations of an AI/ML-based decoder for decoding CSI feedback that uses multiple techniques in accordance with the present disclosure.

FIG. 9 is a block diagram of an example communication system in accordance with an implementation of the present disclosure.

FIG. 10 is a flowchart of a first example process in accordance with an implementation of the present disclosure.

FIG. 11 is a flowchart of a second example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to channel state information (CSI) pre-processing in the two-sided AI/ML architecture for CSI compression with respect to wireless communications. According to the present disclosure, a number of possible solutions may be implemented separately or jointly. That is, although these possible solutions may be described below separately, two or more of these possible solutions may be implemented in one combination or another.

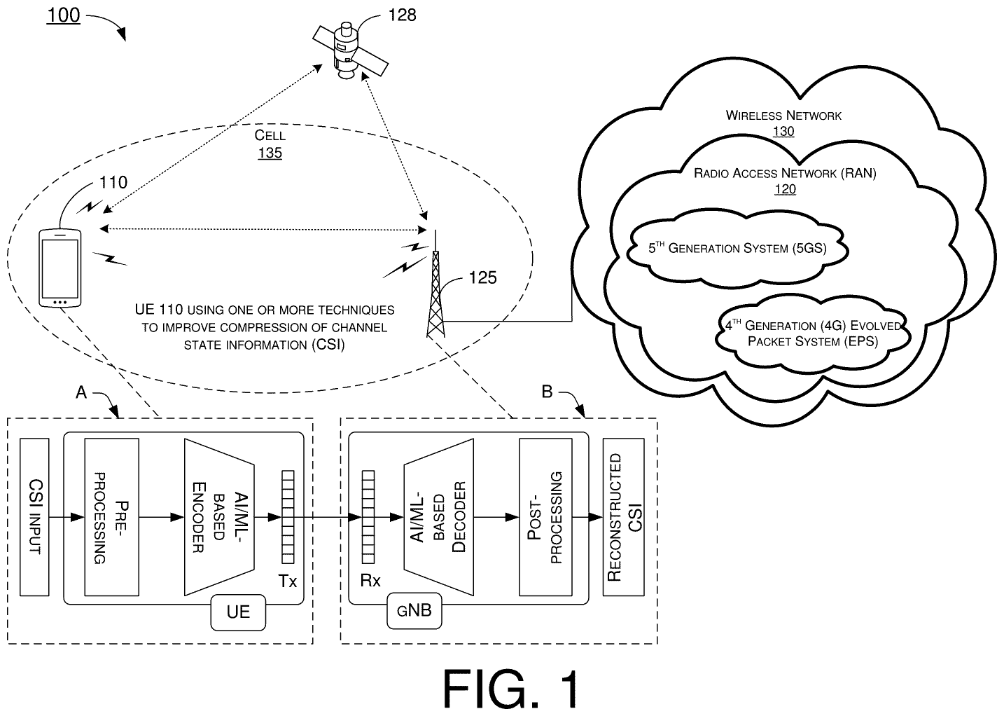

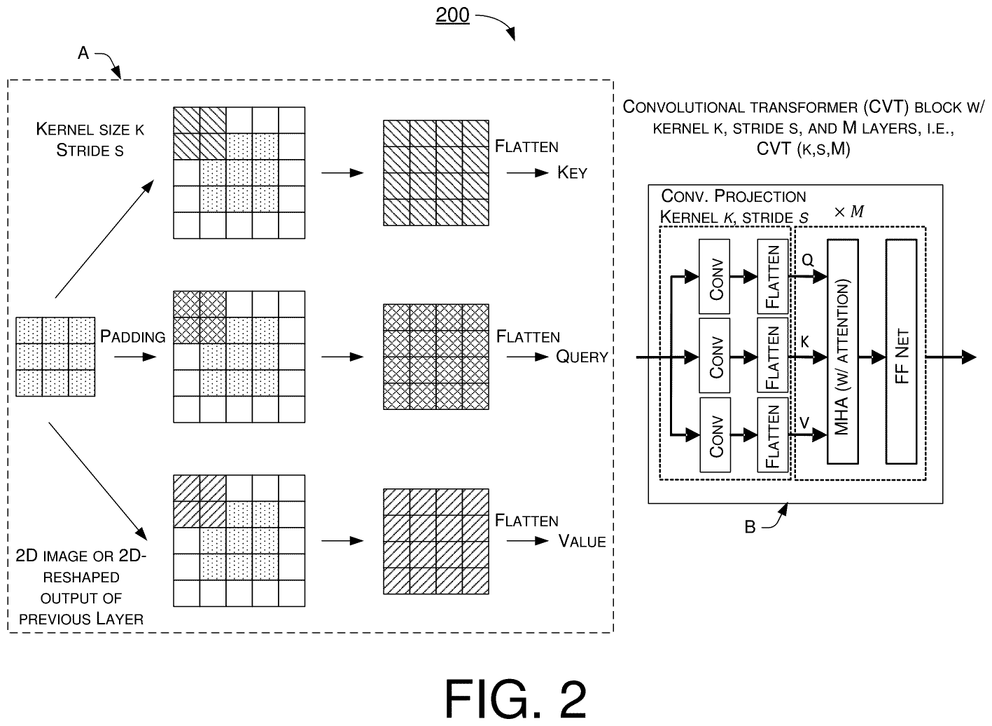

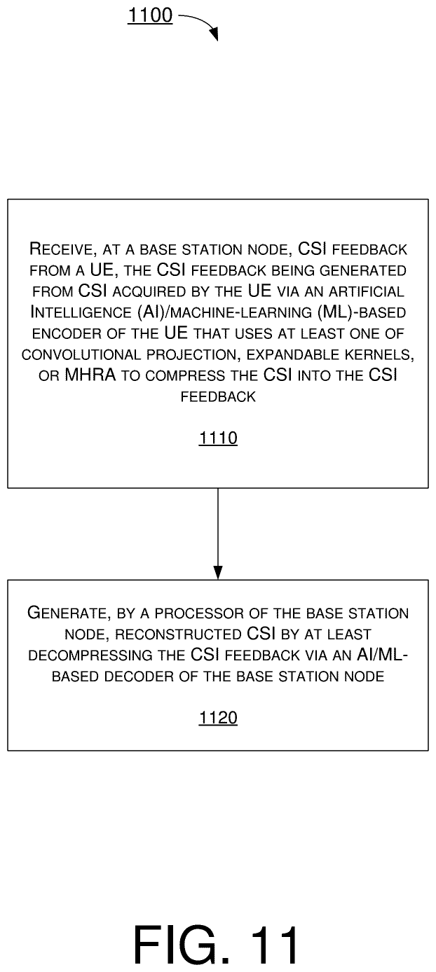

FIG. 1 illustrates an example network environment 100 in which various solutions and schemes in accordance with the present disclosure may be implemented. FIG. 2-FIG. 11 illustrate examples of various proposed schemes in network environment 100 in accordance with the present disclosure. The following description of various proposed schemes is provided with reference to FIG. 1-FIG. 11.

Referring to FIG. 1, network environment 100 may include a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)) and/or a non-terrestrial network node 128 (e.g., a satellite). That is, UE 110 may be within coverage of a cell 135 associated with terrestrial network node 125 or non-terrestrial network node 128. RAN 120 may be a part of a network 130. In network environment 100, UE 110 and network 130 (via terrestrial network node 125 or non-terrestrial network node 128 of RAN 120) may implement various schemes pertaining to CSI compression and decompression in wireless communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Referring to Part (A) of FIG. 1, the UE 110 may provide CSI feedback to a base station node (e.g., the terrestrial network node 125 or non-terrestrial network node 128) using the two-sided AI/ML architecture for CSI compression. In such an architecture, the CSI initially acquired by a UE, which includes the channel matrix and other information that is measured, computed, and/or estimated by the UE, may be referred to as raw CSI. The raw CSI may then be pre-processed by a pre-processing function of the UE. Subsequently, the CSI feedback may be generated by an AI/ML-based encoder on that UE that compresses the pre-processed CSI. The CSI feedback is then sent to the base station node. Referring to Part (B) of FIG. 1, the base station node receives the CSI feedback and decompresses the CSI feedback using an AI/ML-based decoder to reconstruct the CSI. In some instances, post-processing may be further applied by the base station node following decompression to reconstruct the CSI.

In various scenarios, the raw CSI may be very chaotic, i.e., has high entropy, in an antenna-frequency domain. As a result, the pre-processed CSI that is generated from the raw CSI may be difficult to compress by the AI/ML-based encoder. In such instances, the raw or pre-processed CSI may be translated into a sparser beam-delay domain that has less entropy for compression by an AI/ML-based encoder. Existing AI/ML models, i.e., auto-encoders (AEs), that are used as AI/ML-based encoders for CSI compression may include a convolutional neural network (CNN)-based AE, a transformer-based AE, a window transformer-based AE, etc. Nevertheless, it will be appreciated that the architecture illustrated in FIG. 1 may be applied to various compression and decompression scenarios. In addition to the use of a channel matrix or its delay-beam domain translation for compression and decompression as described above, the eigenvectors of a channel covariance matrix or its beam-domain translation may be similarly used for compression and decompression in other scenarios.

However, each of these AEs may have some drawbacks. For example, a CNN-based AE makes use of local receptive fields (RF) that do not cover an entire input but only capture correlation with each local RF. This is because CNNs use limited-size kernels for the CSI elements in the beam-delay domain and only calculate correlation among elements in each kernel. As a result, the CNN-based AE is unable to capture correlations between elements that are far from each other (e.g., elements that are in different regions or kernels). In another example, a transformer-based AE makes use of a global RF in which the RF is a global region that covers all the CSI elements in a layer of the transformer in the beam-delay domain. Further, within the global region, the CSI elements are defined into words, in which each word includes all the elements that are in a particular column and each column corresponds to a specific delay value of the beam-delay domain in the delay vector (axis). Thus, a column may consist of all the CSI elements in a column that runs along the beam vector (axis) of the beam-delay domain. In this way, correlations between all words in each layer of the transformer may be calculated. However, such global comparison of words requires high computational complexity that consumes a large amount of computing resources, as the number of floating-point operations per second (FLOPs) is high. In alternative scenarios, words may also be similarly defined for CSI elements with respect to the delay vector of the beam-delay domain, defined for CSI elements with respect to a spatial vector of a spatial-frequency domain, or defined for CSI elements with respect to a frequency vector in the spatial-frequency domain. Nevertheless, global comparisons of words in such alternative scenarios require similar high computational complexity.

In an additional example, a window transformer-based AE is similar to the transformer-based AE, except that the window transformer-based AE does not compare all the words with each other. Instead, the CSI elements in a layer are divided into patches (e.g., a rectangular grouping of elements, such as a 2×2 group of elements) and the patches are clustered into windows. The patches serve the same purpose as words in a transformer-based AE. Accordingly, the patches of elements in a window are correlated with each other in a window-transformer AE. Further, the windows of different layers of the window-transformer AE may be shifted as correlation is performed for each layer. The window transformer-based AE has reduced computational complexity as compared to the transformer-based AE. However, since the comparison is between patches within each window, the window transformer-based AE is unable to capture correlations between patches of elements that are different windows. In other words, the window transformer-based AE may struggle to capture long-distance dependencies in the layers, i.e., correlations between CSI elements in each layer that are relatively far away from each other.

Additionally, while transformer-based AEs are able to provide global RF, they generally only consider correlation in one-dimension (1D) due to the use of words in the form of columns. Thus, in a beam-delay domain, i.e., such transformer-based AEs may only consider correlations between CSI elements in the delay vector (axis) of the beam-delay domain. However, in the real world, a physical configuration of antennas that are positioned near each other may result in CSI elements that are not only correlated in the delay vector (axis), but also correlated in the beam vector (axis) of the beam-delay domain. Thus, transformer-based AEs may be unable to adequately make two-dimensional (2D) correlations for CSI elements in a layer. This problem does not exist in window transformer-based AEs, as the window transformer-based AEs use 2D rectangular patches of elements that span multiple vectors (axes). However, the use of patches in window transformer-based AEs may cause its own problems. This is because patches are generally fixed in resolution, i.e., the size of a patch cannot increase or change across a layer. This may be problematic because different regions of a layer may have different levels of information while having similar contributions to computational complexity. For example, regions of a layer with CSI elements that have highly disparate values may be best served by patches with higher resolution, e.g., a smaller patch that covers fewer elements, while regions of a layer with CSI elements that have fairly uniform values may be best served by patches with lower resolutions, e.g., a larger patch that covers more elements. However, since all patches are of the same resolution and take similar amounts of computational resources to process, the benefit of reducing computational complexity by varying patch resolution cannot be realized.

Another problem that is present with the use of AEs for CSI compression is attention collapse. As the number of transformation layers in the design of a transformer-based AE increases over a threshold, the addition of new transformation layers may not provide additional processing capacity to the AE. This is because the new layers are not able to attend to new features. Instead, the new layers may simply repeat the same operations that are performed by the existing layers.

To alleviates these problems, techniques such as convolution projection, expandable kernels, convolutional transformer (CVT), and/or CVT with re-attention may be applied individually or in combination to improve the ability of AEs to compress CSI. Thus, the techniques in accordance with the present disclosure provide several advantages over existing CSI compression techniques. For example, the techniques in accordance with the present disclosure may provide CSI-suited embedding using convolution projection that maps the most correlative elements of CSI into one word (Key, Query, or Value), as well as presents words with overlapping information. Further, the techniques may provide for the use of expandable kernels to concentrate the focus of AEs on the most informative parts of CSI. Additionally, the techniques may integrate convolutional transformers with re-attention into deep AE architectures for CSI compression with high accuracy. As a result, the techniques may reduce the complexity of AEs used for CSI processing.

FIG. 2 illustrates a first technique for improving CSI compression in accordance with the present disclosure. This technique involves the use of convolutional projection on CSI elements that results in a convolutional transformer. As shown in Part (A) of FIG. 2, in the use of convolutional projection, a square-shaped kernel may be configured to move on top of CSI elements in an output of a previous layer to generate a word for Key, a word for a Query, and a word for Value, in which Key, Query, and Value are parameter inputs to the transformer. While the output of the previous layer may be in one of the various multi-dimensional forms (e.g., 2D, 3D, or 4D), the output can be 2D-reshaped so that the output only applies in two dimensions. The output of the previous layer may be padded to add elements to the boundary of the output. Accordingly, the square-shaped kernel having a kernel size (k) may move around the padded output of the previous layer according to stride (s) to capture correlations between the CSI elements in the padded output for each of Key, Query, and Value parameters. Subsequently, the correlations between the elements in the padded output as captured for each of the Key, Query, and Value parameters may be flattened by a flattening function of a transformer into a corresponding output that is the corresponding word for each of the Key, Query, and Value parameters.

In this way, the use of the squared-shape kernel that encompasses multiple elements enables 2D local correlations to be captured so that dependencies may be better preserved through the use of overlapping words. Part (B) of FIG. 2 shows the implementation of the convolution projection that includes the use of square-shaped kernels in an example convolutional transformer (CVT) block. As shown, the convolution projection generates Key, Query, and Value inputs for the CVT with multiple convolutional layers, in which each layer may include a multi-head attention (MHA) function and a feature fusion network (FF Net). The arguments for the CVT include kernel size (k), number of strides (s), and number of layers (M). Thus, such a CVT block may be used repeatedly in an AE to capture advanced features in the CSI.

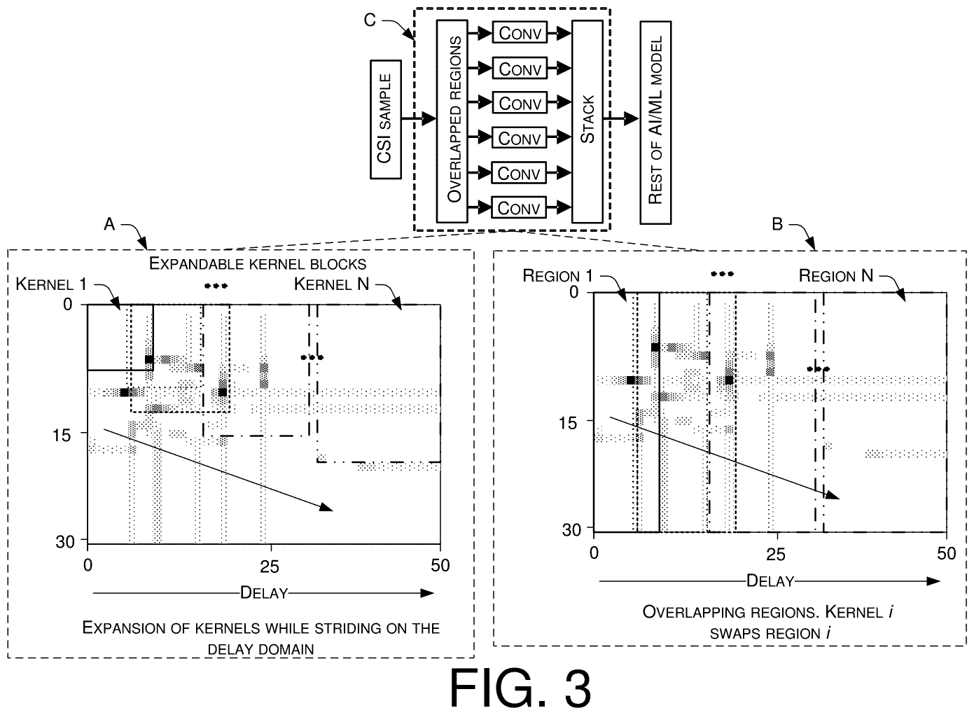

FIG. 3 illustrates a second technique for improving CSI compression in accordance with the present disclosure. This technique involves the use of expandable kernels to provide variable resolution for CSI elements of an input layer for an AE, such as an input layer of CSI elements in the beam-delay domain. For example, during the use of convolutional kernels for correlating CSI elements in such an input layer, some regions of an input layer may benefit from higher resolution, while other regions may benefit from lower resolution. This is because larger delays do not carry as much information as small delays, thus it is better to expand kernel size as the kernel strides toward the larger delays so that the AI/ML model of the AE focuses on the more informative CSI elements associated with smaller delays. In the example shown in Part (A), kernel size (k) may be adjusted during stride to produce kernels of expanding size as kernel striding occurs across the delay vector of the beam-delay domain. As shown in Part (B), the use of expandable kernels may result in the generation of overlapping regions in the input layer, such that the correlations between the overlapped regions may be further captured. Part (C) of FIG. 3 shows an example implementation of an AE in which a CSI sample of a CSI input layer may be processed with the use of overlapping regions that result from the use of expandable kernels, and then processed using convolutional layers. The output of the convolutional layers are further stacked by a stack function for input to the rest of the AI/ML model (AE).

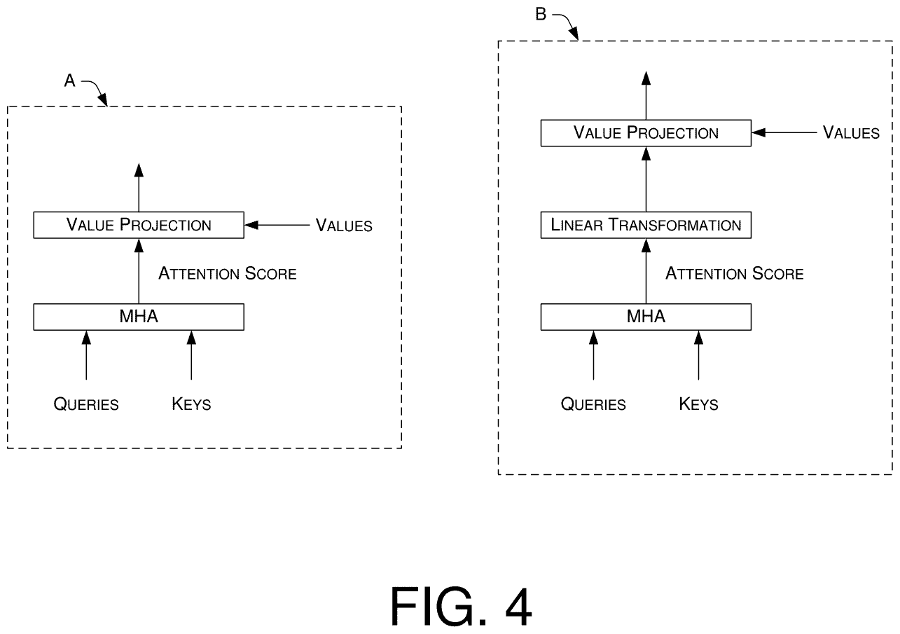

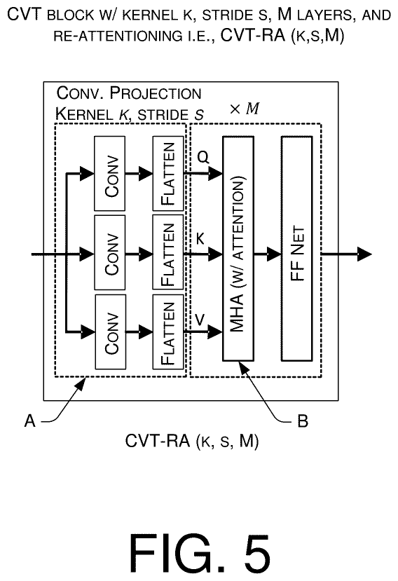

FIG. 4 illustrates a third technique for improving CSI compression in accordance with the present disclosure. This technique involves the use of multi-head re-attention (MHRA) to address the attention collapse problem during the processing of CSI. The use of such techniques means that the use of an MHA may be replaced with MHRA in deep AE architectures, such as AE architectures that use CVT blocks. Unlike in MHA (Part A), MHRA (Part B) defines new attention based on a linear combination of the attention score for query-key pairs, e.g., a linear transformation of the attention score. The coefficient of such a linear transformation is learnable and adjustable such that a convolution transformer is able to generate new attention maps with informative and new features that can be used by the AE to compress or decompress the CSI. FIG. 5 illustrates an example implementation of MHRA in a convolutional transformer with re-attention (CVT-RA) block in accordance with the present disclosure. Similar to the implementation illustrated in FIG. 2, this implementation includes the use of a CVT with multiple convolutional layers, in which the arguments for the CVT include kernel size (k), number of strides (s), and number of layers (M). However, unlike the implementation illustrated in FIG. 2, each layer of CVT may use an MHRA function instead of an MHA function (Part B).

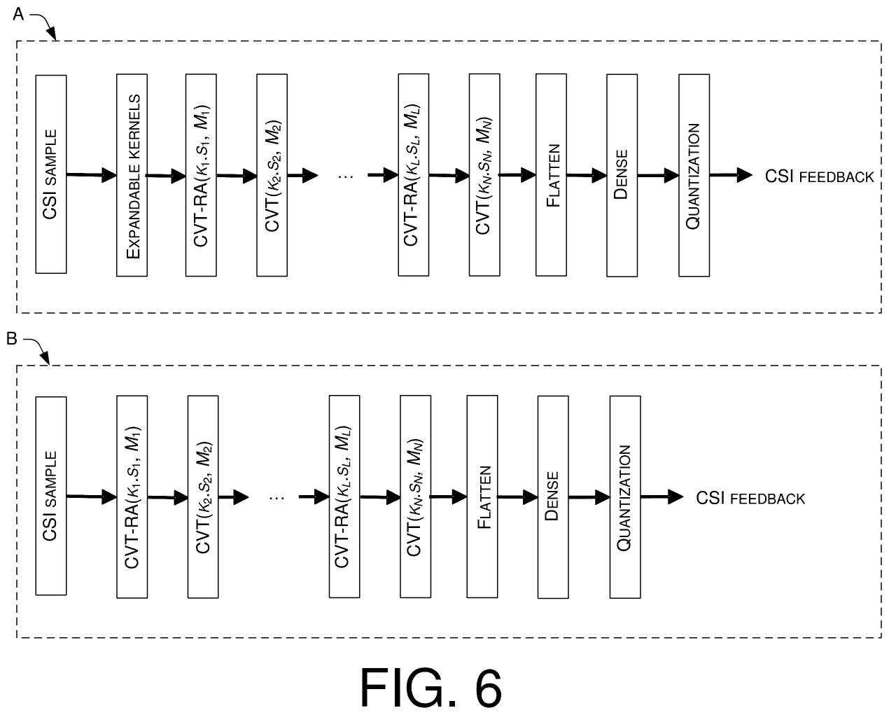

FIG. 6 illustrates example implementations of an AI/ML-based encoder for encoding CSI that uses multiple techniques in accordance with the present disclosure. As shown in Part (A), a first example AI/ML-based encoder for compressing a CSI sample into a CSI feedback may be implemented with the use of expandable kernels, as well as the use of only CVT blocks, only CVT-RA blocks, or a combination of both CVT and CVT-RA blocks in multiple transformer layers. As shown in Part (B), a second example AI/ML-based encoder for compressing a CSI sample into a CSI feedback may be implemented with only CVT blocks, only CVT-RA blocks, or a combination of both CVT and CVT-RA blocks in multiple transformer layers, but without the use of expandable kernels.

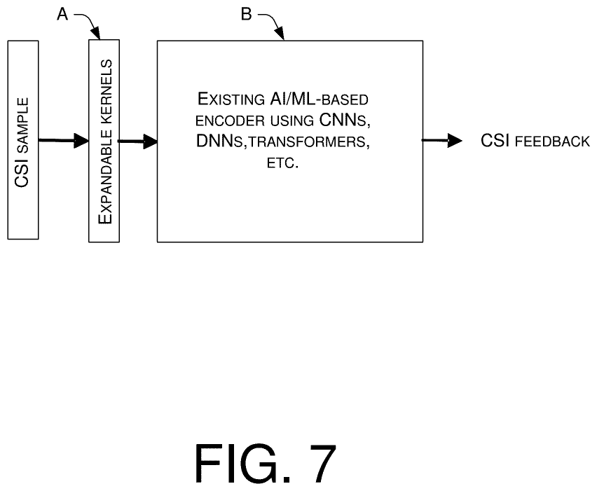

FIG. 7 illustrates an example implementation of an AI/ML-based encoder for encoding CSI that uses expandable kernels with existing AI/ML-based encoders in accordance with the present disclosure. As shown, a CSI sample may be initially processed using expandable kernels (Part A), and then further processed into CSI feedback using an existing AI/ML-based encoder, such as an encoder that uses CNNs, Deep Neural Networks (DNNs), transformers, and/or so forth (Part B).

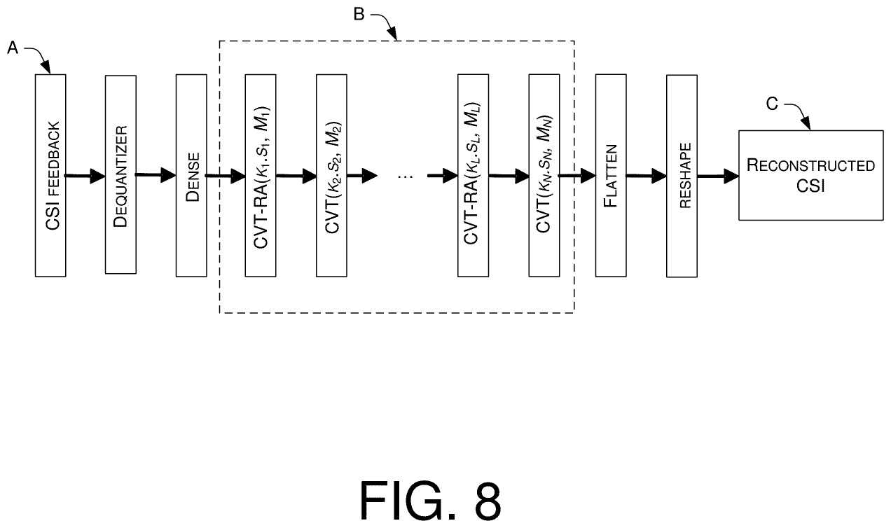

FIG. 8 illustrates example implementations of an AI/ML-based decoder for decoding CSI feedback that uses multiple techniques in accordance with the present disclosure. As shown, an example AI/ML-based decoder for decompressing a CSI feedback (Part A) into reconstructed CSI (Part B) may be implemented with the use of only CVT blocks, only CVT-RA blocks, or a combination of both CVT and CVT-RA blocks in multiple transformer layers (Part C).

### Illustrative Implementations

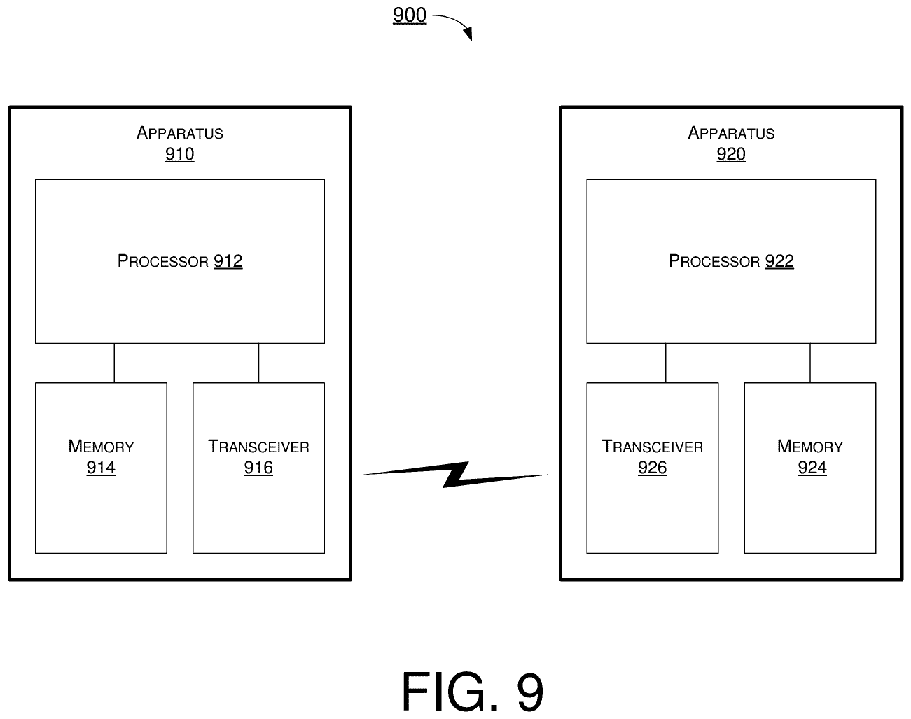

FIG. 9 illustrates an example communication system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 910 and apparatus 920 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 910 and apparatus 920 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in an eNodeB in an LTE, LTE-Advanced or LTE-Advanced Pro network or in a gNB or TRP in a 5G network, an NR network or an IoT network.

In some implementations, each of apparatus 910 and apparatus 920 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 910 and apparatus 920 may be implemented in or as a network apparatus or a UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC or RISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to CSI compression and decompression in wireless communications in accordance with various implementations of the present disclosure.

In some implementations, apparatus 910 may also include a transceiver 916 coupled to processor 912. Transceiver 916 may be capable of wirelessly transmitting and receiving data. In some implementations, transceiver 916 may be capable of wirelessly communicating with different types of wireless networks of different radio access technologies (RATs). In some implementations, transceiver 916 may be equipped with a plurality of antenna ports (not shown) such as, for example, four antenna ports. That is, transceiver 916 may be equipped with multiple transmit antennas and multiple receive antennas for multiple-input multiple-output (MIMO) wireless communications. In some implementations, apparatus 920 may also include a transceiver 926 coupled to processor 922. Transceiver 926 may include a transceiver capable of wirelessly transmitting and receiving data. In some implementations, transceiver 926 may be capable of wirelessly communicating with different types of UEs/wireless networks of different RATs. In some implementations, transceiver 926 may be equipped with a plurality of antenna ports (not shown) such as, for example, four antenna ports. That is, transceiver 926 may be equipped with multiple transmit antennas and multiple receive antennas for MIMO wireless communications.

In some implementations, apparatus 910 may further include a memory 914 coupled to processor 912 and capable of being accessed by processor 912 and storing data therein. In some implementations, apparatus 920 may further include a memory 924 coupled to processor 422 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a UE (e.g., UE 110), and apparatus 920, as a network node (e.g., network node 125) of a network (e.g., network 130 as a 5G/NR mobile network), is provided below in the context of example processes 1000 and 1100.

### Illustrative Processes

Each of the processes 1000 and 1100 may represent an aspect of implementing various proposed designs, concepts, schemes, systems and methods described above, whether partially or entirely, including those pertaining to those described above. Each process may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Each process may be implemented by or in apparatus 910 and/or apparatus 920 as well as any variations thereof. Solely for illustrative purposes and without limiting the scope, each process is described below in the context of apparatus 910 as a UE (e.g., UE 110) and apparatus 920 as a communication entity such as a network node or base station (e.g., terrestrial network node 125 or non-terrestrial network node 128) of a network (e.g., network 130 as a 5G/NR mobile network).

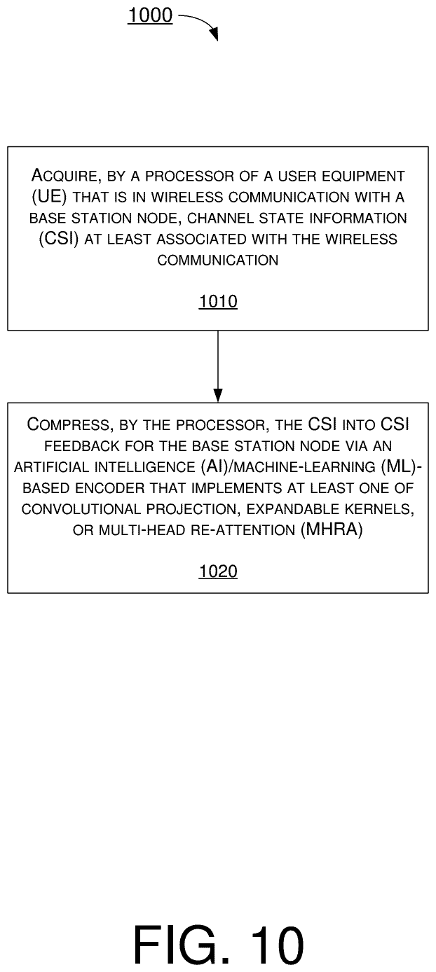

FIG. 10 illustrates an example process 1000 in accordance with an implementation of the present disclosure. Process 1000 may begin at block 1010. At 1010, process 1000 may include processor 912 of apparatus 910 acquiring CSI at least associated with the wireless communication. Process 1000 may proceed from 1010 to 1020.

At 1020, process 1000 may include processor 912 compressing the CSI into CSI feedback for the base station node via an AI/ML-based encoder that uses at least one of convolutional projection, expandable kernels, or MHRA.

In some implementations, in implementing the convolution projection, process 1000 may include processor 912 performing certain operations. For instance, process 1000 may include processor 912 applying a square-shaped kernel that moves around a layer of CSI elements to capture correlations between the CSI elements for each of Key, Query, and Value parameters. Additionally, process 1000 may include processor 912 applying a flattening function to flatten the correlations in the CSI elements as captured for each of the Key, Query, and Value parameters into a corresponding word for each of the Key, Query, and Value parameters.

In some implementations, in implementing the expendable kernels, process 1000 may include processor 912 performing certain operations. For instance, process 1000 may include processor 912 adjusting sizes of kernels as kernel striding occurs over an input layer of CSI elements in the beam-delay domain based on magnitudes of delays indicated in the beam-delay domain.

In some implementations, in implementing the MHRA, process 1000 may include processor 912 performing certain operations. For instance, process 1000 may include processor 912 processing a layer of CSI elements via a CVT-RA block of the AI/ML-based encoder that comprises an MHRA function, in which the MHRA defines new attention based on a linear combination of an attention score for query-key pairs to generate new attention maps with features for use by the AI/ML-based encoder that processes the CSI.

In some instances, the AI/ML-based encoder includes at least one of a CVT block, a CVT-RA block, or expandable kernels to process the CSI. In other instances, the AI/ML-based encoder includes expandable kernels and at least of a CNN, a DNN, or a transformer to process the CSI.

FIG. 1100 illustrates an example process 1100 in accordance with an implementation of the present disclosure. Process 1100 may begin at block 1110. At 1110, process 1100 may include processor 922 of apparatus 920 receiving CSI feedback from apparatus 910, the CSI feedback being generated from CSI acquired by an AI/ML-based encoder of apparatus 910 that uses at least one of convolutional projection, expandable kernels, or MHRA to compress the CSI into the CSI feedback. Process 1100 may proceed from 1110 to 1120.

At 1120, process 1100 may include processor 922 generating reconstructed CSI by at least decompressing the CSI feedback via an AI/ML-based decoder of the base station node. Additionally, process 900 may further include processor 922 performing one or more tasks based on the reconstructed CSI. For example, the one or more tasks may include scheduling beamforming for one or more antennas of the base station node. In some instances, the AI/ML-based decoder includes at least one of a CVT block or a CVT-RA block with a MHRA function to process the CSI feedback.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
acquiring, by a processor of a user equipment (UE) that is in wireless communication with a base station node, channel state information (CSI) at least associated with the wireless communication; and
compressing, by the processor, the CSI into CSI feedback for the base station node via an artificial intelligence (AI) or machine-learning (ML)-based encoder that implements at least one of convolutional projection, expandable kernels, or multi-head re-attention (MHRA).

2. The method of claim 1, wherein the CSI acquired by the UE is raw CSI, further comprising, prior to compressing the CSI into the CSI feedback, pre-processing, by the processor, the CSI into pre-processed CSI using a pre-processing function of the UE.

3. The method of claim 1, wherein implementing the convolutional projection includes:
applying a square-shaped kernel that moves around a layer of CSI elements to capture correlations between the CSI elements for each of Key, Query, and Value parameters; and
applying a flattening function to flatten the correlations in the CSI elements as captured for each of the Key, Query, and Value parameters into a corresponding word for each of the Key, Query, and Value parameters.

4. The method of claim 1, further comprising, prior to compressing the CSI into the CSI feedback, translating, by the processor, the CSI that is in an antenna-frequency domain to a beam-delay domain to reduce an entropy of the CSI.

5. The method of claim 4, wherein implementing the expandable kernels includes adjusting sizes of kernels as kernel striding occurs over an input layer of CSI elements in the beam-delay domain based on magnitudes of delays indicated in the beam-delay domain.

6. The method of claim 1, wherein implementing the MHRA includes processing a layer of CSI elements via a convolutional transformer with re-attention (CVT-RA) block of the AI or ML-based encoder that comprises an MHRA function.

7. The method of claim 6, wherein the MHRA defines new attention based on a linear combination of an attention score for query-key pairs to generate new attention maps with features for use by the AI or ML-based encoder that processes the CSI.

8. The method of claim 1, wherein the AI or ML-based encoder includes at least one of a convolutional transformer (CVT) block, a convolutional transformer with re-attention (CVT-RA) block, or expandable kernels to process the CSI.

9. The method of claim 1, wherein the AI or ML-based encoder includes expandable kernels and at least of a convolution neural network (CNN), a deep neural network (DNN), or a transformer to process the CSI.

10. A method, comprising:
receiving, at a base station node, channel state setting (CSI) feedback from a user equipment (UE), the CSI feedback being generated from CSI acquired by the UE via an artificial intelligence (AI) or machine-learning (ML)-based encoder of the UE that implements at least one of convolutional projection, expandable kernels, or multi-head re-attention (MHRA) to compress the CSI into the CSI feedback; and
generating, by a processor of the base station node, reconstructed CSI by at least decompressing the CSI feedback via an AI or ML-based decoder of the base station node.

11. The method of claim 10, further comprising performing, by a processor of the base station node, one or more tasks based on the reconstructed CSI.

12. The method of claim 11, wherein the one or more tasks include scheduling beamforming for one or more antennas of the base station node.

13. The method of claim 10, wherein the base station node is a gNodeB of a wireless carrier network.

14. The method of claim 10, wherein the AI or ML-based decoder includes at least one of a convolutional transformer (CVT) block or a convolutional transformer with re-attention (CVT-RA) block with a multi-head re-attention (MHRA) function to process the CSI feedback.

15. An apparatus implementable in a user equipment (UE) that is in wireless communication with a base station node, comprising:
a transceiver configured to communicate wirelessly; and
a processor coupled to the transceiver and configured to perform operations comprising:
acquiring channel state information (CSI) at least associated with the wireless communication; and
compressing the CSI into CSI feedback for the base station node via an artificial intelligence (AI) or machine-learning (ML)-based encoder that implements at least one of convolutional projection, expandable kernels, or multi-head re-attention (MHRA).

16. The apparatus of claim 15, wherein implementing the convolutional projection includes:
applying a square-shaped kernel that moves around a layer of CSI elements to capture correlations between the CSI elements for each of Key, Query, and Value parameters; and
applying a flattening function to flatten the correlations in the CSI elements as captured for each of the Key, Query, and Value parameters into a corresponding word for each of the Key, Query, and Value parameters.

17. The apparatus of claim 15, wherein the operations further comprise, prior to compressing the CSI into the CSI feedback, translating the CSI that is in an antenna-frequency domain to a beam-delay domain to reduce an entropy of the CSI.

18. The apparatus of claim 17, wherein implementing the expandable kernels includes adjusting sizes of kernels as kernel striding occurs over an input layer of CSI elements in the beam-delay domain based on magnitudes of delays indicated in the beam-delay domain.

19. The apparatus of claim 15, wherein implementing the MHRA includes processing a layer of CSI elements via a convolutional transformer with re-attention (CVT-RA) block of the AI or ML-based encoder that comprises an MHRA function.

20. The apparatus of claim 19, wherein the MHRA defines new attention based on a linear combination of an attention score for query-key pairs to generate new attention maps with features for use by the AI or ML-based encoder that processes the CSI.
